(19) United States
(12) Patent Application Publication
(10) Pub. No.: US 2020/0089261 A1
(43) Pub. Date: Mar. 19, 2020

(54) CURRENT CONTROL DEVICE

(71) Applicant: DENSO CORPORATION, Kariya-city (JP)

(72) Inventors: Masaaki KONO, Nisshin-city (JP); Yusuke KIMURA, Nisshin-city (JP); Fukuo KITAGAWA, Nisshin-city (JP); Takahiro TOMEDA, Nisshin-city (JP); Tadayoshi NAKASE, Nisshin-city (JP); Shinichi KONDO, Kariya-city (JP); Kazuhiro SASAO, Kariya-city (JP); Masato ARAI, Kariya-city (JP); Motoyoshi ANDO, Kariya-city (JP)

(21) Appl. No.: 16/573,074

(22) Filed: Sep. 17, 2019

(30) Foreign Application Priority Data
Sep. 19, 2018 (JP) 2018-175085

(51) Int. Cl. G05D 16/20; F16K 31/06; G05B 19/042

(52) U.S. Cl. CPC G05D 16/2022; F16K 31/0675; G05B 2219/25252; G05B 19/042; F16K 31/0613

(57) ABSTRACT

A current control device includes a target setting unit, a storage unit, an oil pressure ratio calculation unit, a specific current detection unit and a correction unit. The target setting unit adds a dither amplitude to a target current so that the current of the solenoid periodically changes at a dither cycle period longer than a PWM cycle period of the solenoid. The storage unit stores a stroke-current relationship between a stroke of the spool and the current of the solenoid. The oil pressure ratio calculation unit calculates an oil pressure ratio which is a value calculated by dividing an amplitude of the output oil pressure by an average value of the output oil pressure. The specific current detection unit detects a specific current based on the oil pressure ratio. The correction unit corrects the stroke-current relationship based on the specific stroke and the specific current.

### CROSS REFERENCE TO RELATED APPLICATION

The present application is based on Japanese Patent Application No. 2018-175085 filed on Sep. 19, 2018, the whole contents of which are incorporated herein by reference.

### FIELD

The present disclosure relates to a current control device.

### BACKGROUND

A current control device is applied conventionally to a solenoid valve, which controls oil pressure, to control a current supplied to a solenoid. One conventional current control device causes a spool to make minute vibration by adding a dither amplitude to a current supplied to a solenoid thereby suppressing a hysteresis, which is caused by static friction of the spool. In a solenoid valve for oil pressure control, however, an output oil pressure vibrates largely and lowers oil pressure controllability.

### SUMMARY

A current control device according to the present disclosure is provided for controlling a current of a solenoid of a solenoid valve, in which a spool is moved in an axial direction inside a sleeve in accordance with a current supplied to the solenoid to regulate an output oil pressure. The current control device comprises an electronic control unit configured to execute processing of adding a dither amplitude to a target current to change the current of the solenoid periodically at a dither cycle period longer than an energization cycle period of the solenoid. The electronic control unit is configured to improve oil pressure controllability.

### BRIEF DESCRIPTION OF THE DRAWINGS

FIG. 1 is a sectional view of a solenoid valve to which a current control device according to a first embodiment is applied;

FIG. 2 is a block diagram showing function units of the current control device shown in FIG. 1;

FIG. 3 is a time chart showing current control performed by the current control device shown in FIG. 2;

FIG. 4 is a sectional view showing a state where the spool shown in FIG. 1 is at a position of stroke A;

FIG. 5 is a sectional view showing a state where the spool shown in FIG. 1 is at a position of stroke B;

FIG. 6 is a sectional view showing a state where the spool shown in FIG. 1 is at a position of stroke C;

FIG. 7 is a graph showing a relationship between a stroke of the spool shown in FIG. 1 and an oil pressure ratio;

FIG. 8 is a flowchart showing processing executed by the current control device shown in FIG. 1;

FIG. 9 is a block diagram showing function units of a current control device according to a second embodiment;

FIG. 10 is a flowchart showing processing executed by the current control device shown in FIG. 9;

FIG. 11 is a block diagram showing function units of a current control device according to a third embodiment;

FIG. 12 is a graph showing a result of time frequency analysis of an actual current made by an analysis unit shown in FIG. 9;

FIG. 13 is a graph showing a relationship between a target current and a frequency of current generated by a counter-electromotive force; and

FIG. 14 is a flowchart showing processing executed by the current control device shown in FIG. 11.

### DETAILED DESCRIPTION OF EMBODIMENT

A current control device will be described with reference to plural embodiments shown in the accompanying drawings. Substantially the same structures and functions are designated with the same reference numerals throughout the plural embodiments for simplicity of description. In the following embodiments, “oil” refers to fluid.

### First Embodiment

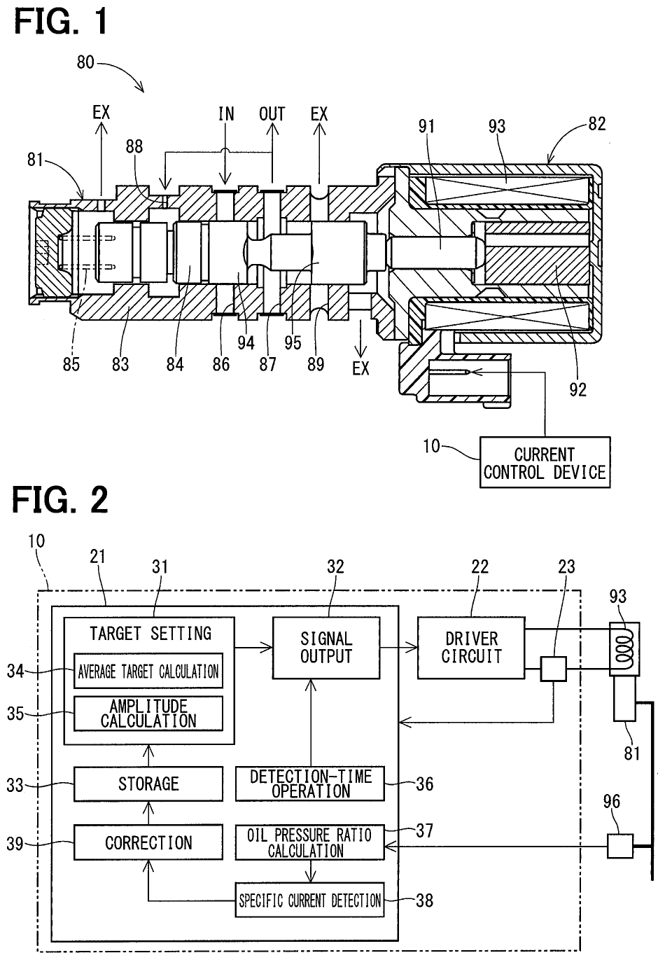

A current control device 10 according to a first embodiment is connected to a solenoid valve 80 as shown in FIG. 1. The solenoid valve 80 includes a spool valve 81 and an electromagnetic unit 82.

The spool valve 81 has a sleeve 83 having various ports 86 to 89, a spool 84 axially movable inside the sleeve 83, and a spring 85 biasing the spool 84 in one axial direction. Oil pumped from an oil pump flows into an input port 86. An output port 87 is connected to an outside device, that is, an oil pressure supply destination, to which the oil pressure is supplied. A part of the oil output from the output port 87 flows into a feedback port 88. A drain port 89 is connected to a drain space (not shown).

The electromagnetic unit 82 includes a shaft 91 and a plunger 92, which are provided on one side in the axial direction with respect to the spool 84, and a solenoid 93, which generates an electromagnetic force when energized by current supply from the current control device 10. The plunger 92 moves in the axial direction in response to the electromagnetic force and presses the spool 84 through the shaft 91.

The spool 84 moves axially with the plunger 92 and the shaft 91 thereby to change the degree of communication between the input port 86 and the output port 87 and the degree of communication between the drain port 89 and the output port 87. An IN land 94 opens and closes the input port 86. An EX land 95 opens and closes the drain port 89. The output oil pressure discharged from the output port 87 changes in accordance with a stroke of the spool 84.

The stroke of the spool 84 is a position where the electromagnetic force of the solenoid 93, the biasing force of the spring 85 and the feedback force of the oil flowing into the feedback port 88 are balanced. The stroke of the spool 84 changes according to the electromagnetic force, and the electromagnetic force changes according to the current of the solenoid 93, which is controlled by the current control device 10.

(Basic Configuration of Current Control Device)

A basic configuration of the current control device 10 will be described next. As shown in FIG. 2, the current control device 10 includes an electronic control unit including a microcomputer 21, a drive circuit 22 and a current detection unit 23 that detects an actual current flowing in the solenoid 93. Hereinafter, when simply described as “current”, it means the actual current of the solenoid 93.

The electronic control unit, particularly the microcomputer 21, is configured to execute programmed processing based on output values of the current detection unit 23 and other devices and sensors, which are not shown. The programmed processing is stored in a memory of the microcomputer 21 and indicated as a plurality of function units. The function units are indicated as a target setting unit 31 that sets a target current of the solenoid 93 according to a target output oil pressure of the solenoid valve 80, and a signal output unit 32 that generates and outputs a drive signal based on the target current. The signal output unit 32 generates the drive signal so that the difference between the actual current and the target current of the solenoid 93 is reduced. The driver circuit 22 energizes the solenoid 93 in a predetermined energization cycle period according to the drive signal. With the current of the solenoid 93 being controlled by the current control device 10, the solenoid valve 80 moves the spool 84 in the axial direction inside the sleeve 83 to thereby regulate the output oil pressure.

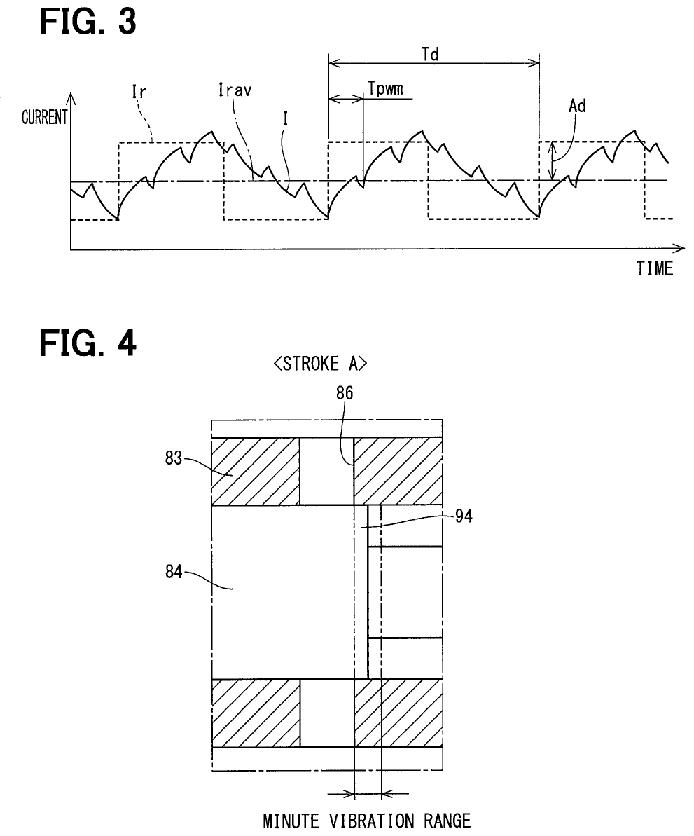

The current control device 10 controls the current of the solenoid 93 by a pulse width modulation signal (PWM signal). As shown in FIG. 3, the operation of energizing the solenoid 93 and then deenergizing the same is repeated at a predetermined PWM cycle period Tpwm, so that an average value of the current I of the solenoid 93 is maintained near an average target current Irav. At this time, the target setting unit 31 applies a dither amplitude Ad to the target current Ir so that the current I changes periodically at a dither cycle period Td longer than the PWM cycle period Tpwm. Thereby, the spool 84 minutely vibrates so that the dynamic friction state of the spool 84 is maintained.

As described above, when the dither control is performed to periodically change the current I of the solenoid 93 at the dither cycle period Td, the hysteresis caused by the static friction of the spool 84 is suppressed. Further, the dither control also has an effect of discharging foreign matters which enter the sliding portion between the sleeve 83 and the spool 84. In the dither control, the spool 84 is minutely vibrated by applying a current waveform shown in FIG. 3 to the solenoid 93. As a result, when the amplitude of the current waveform to be applied, that is, the dither amplitude is large, the amplitude of the minute vibration is also increased.

Depending on the stroke of the spool 84, the IN land 94 may repeat opening and closing of the input port 86 due to the minute vibration. In this case, changes in the oil flow rate and the oil pressure become discontinuous. This change can be a starting point of the oil pressure vibration. If the oil pressure vibration becomes large, it will become impossible to control the oil pressure. Therefore, for improving the oil pressure controllability, it is desirable to reduce a range of stroke (stroke range) of the minute vibration, which causes the opening and closing of the input port 86, by reducing the dither amplitude and hence reducing the amplitude of the minute vibration. However, for reducing friction and removing foreign matters, it is desirable that the amplitude of the minute vibration is large. Therefore, it is proposed to reduce the dither amplitude only when the stroke of the spool 84 is at the position that involves the opening and closing of the input port 86. For this purpose, it is necessary to detect the stroke of the spool 84.

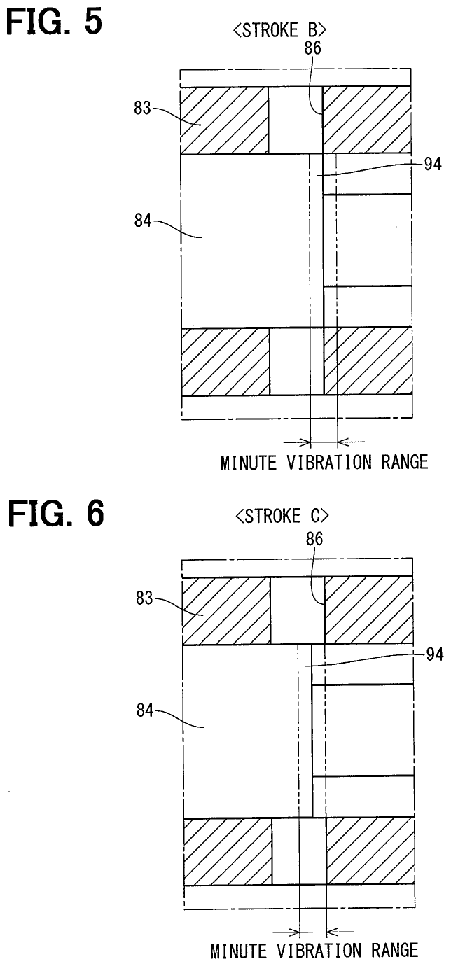

Here, the change of a partition part according to the stroke of the spool 84 is shown in FIG. 4 to FIG. 6. At the position of the stroke A shown in FIG. 4, the input port 86 is momentarily opened by the minute vibration. When the spool 84 is moved to the position of the stroke B shown in FIG. 5, the center of the minute vibration coincides with the axial end (that is, the partition) of the input port 86. Further, when the spool 84 is moved to the position of the stroke C shown in FIG. 6, the input port 86 is momentarily closed by the minute vibration. The strokes A to C are the positions which cause the opening and closing of the input port 86 described above.

In order to detect the stroke of the spool, a gap sensor may be used as proposed conventionally. However, addition of a new sensor such as a gap sensor increases manufacturing cost.

As a method to detect a stroke of a spool without adding a sensor, it is proposed to estimate a stroke based on an actual current supplied to a solenoid valve by determining a relationship between the stroke and the actual current in advance. However, there is a problem that an error occurs due to individual differences of products and aging of oil and a solenoid valve. The current control device 10 according to the first embodiment includes function units for solving such a problem and improving oil pressure controllability.

(Function Units of Current Control Device)

Function units of the current control device 10 will be described below. In the following description, the stroke of the spool 84 means the center position in the range of the minute vibration generated by dither control. Further, the stroke when the spool 84 just closes the input port 86 as a specific port is referred to as a specific stroke (stroke B shown in FIG. 5). Further, the current of the solenoid 93 corresponding to the specific stroke is referred to as a specific current.

As shown in FIG. 2, the current control device 10 includes, as further function units, a storage unit 33 and a target setting unit 31. The storage unit 33 stores a pressure-stroke relationship, which defines a relationship between the output oil pressure and the stroke of the spool 84, and a stroke-current relationship, which defines a relationship between the stroke of the spool 84 and the current of the solenoid 93.

The target setting unit 31 includes an average target calculation unit 34 and an amplitude calculation unit 35. The average target calculation unit 34 calculates an average target current Irav based on a target output oil pressure. Specifically, the average target calculation unit 34 calculates the target stroke based on the target output oil pressure from the pressure-stroke relationship, and subsequently calculates the average target current Irav based on the target stroke from the stroke-current relationship. The amplitude calculation unit 35 calculates the dither amplitude Ad based on the average target current Irav and an oil temperature To of the operation oil and the like.

During normal control where the output oil pressure is required to be output to the outside device, the signal output unit 32 generates a drive signal based on the target current set as described above, and the driver circuit 22 energizes the solenoid 93 by current supply corresponding to the drive signal. As a result, the spool 84 moves to regulate the output oil pressure.

The current control device 10 further includes a detection-time operation unit 36, an oil pressure ratio calculation unit 37, a specific current detection unit 38 and a correction unit 39.

The detection-time operation unit 36 moves the spool 84 in the axial direction from a minimum to a maximum of the stroke range while minutely vibrating the spool 84 by applying the dither amplitude at predetermined time at which the output oil pressure is not required to be output. The predetermined time at which the output oil pressure is not required to be output is, for example, an ACC-ON time period of an accessory switch before starting the engine or the ACC-ON time period after stopping the engine.

The oil pressure ratio calculation unit 37 calculates an oil pressure ratio which is a value calculated by dividing the amplitude of the output oil pressure by the average value of the output oil pressure. The oil pressure ratio calculation by the oil pressure ratio calculation unit 37 is performed when the detection-time operation unit 36 moves the spool 84 in the axial direction. The output oil pressure may be detected by a detection signal of an oil pressure sensor 96 provided conventionally. Therefore, there is no need to add a new sensor.

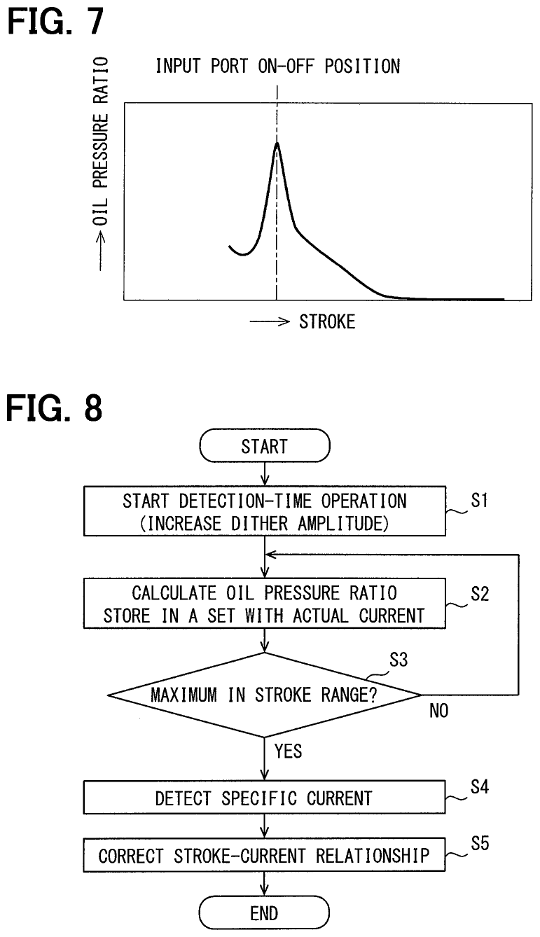

The specific current detection unit 38 detects the specific current based on the oil pressure ratio. Specifically, the specific current detection unit 38 detects, as the specific current, the current of the solenoid 93 when the oil pressure ratio becomes maximum as shown in FIG. 7 at the time the spool 84 is moved in the axial direction by the detection-time operation unit 36.

The stroke at which the oil pressure ratio is maximum is the stroke B shown in FIG. 5. This is because the center of the minute vibration caused by the dither control is the edge of the input port 86, and the open time period and the closed time period are equal to each other. When opening and closing the input port 86 is repeated, the discontinuous change in oil pressure decreases as the opening time period approaches 0 and the closing time period approaches 0. On the other hand, the largest change in the oil pressure is at the position where the opening and closing time periods are equal, that is, the stroke B. Using this relationship, the stroke of the spool 84 can be detected by regarding the point where the oil pressure ratio is maximum as the point where the spool 84 is at the position of the stroke B. Here, it is an advantage of calculating the oil pressure ratio that only the oil pressure change due to the opening and closing of the input port 86 can be separated. The change in the oil pressure is affected by changes in the oil pressure caused by various factors in addition to the change caused by the opening and closing of the input port 86. Since the oil pressure change due to these other factors occurs at a rate relative to an absolute value of the oil pressure, the change caused by the opening and closing of the input port 86 can be separated by dividing the amplitude of the oil pressure change by the oil pressure average value.

Referring back to FIG. 2, the correction unit 39 corrects the stroke-current relationship stored in the storage unit 33 based on the specific stroke and the specific current. That is, by accurately detecting the timing at which the spool 84 is positioned at the stroke B (that is, specific stroke) and correcting the stroke-current relationship in accordance with the current at that time, that is, the specific current, errors caused by individual difference among products and aging of the operation oil and the solenoid valve can be suppressed.

The detection-time operation unit 36 increases the dither amplitude at the predetermined time at which the output oil pressure is not required to be output, as compared to the normal control time at which the output oil pressure is required to be output. As a result, oil pressure vibration can be intentionally generated to make the hydraulic ratio peak clear. In another embodiment, the dither cycle period may be reduced instead of increasing the dither amplitude.

The amplitude calculation unit 35 of the target setting unit 31 decreases the dither amplitude when the stroke of the spool 84 is at the position accompanied by the opening and closing of the input port 86 by the minute vibration at the normal control time in comparison to a case that the stroke of the spool 84 is the position not accompanied by the opening and closing of the input port 86 by the minute vibration. As a result, the dither amplitude can be reduced at the position of the stroke range involving the opening and closing of the input port 86 to reduce the oil pressure change while increasing the amplitude of the minute vibration in the widest stroke range as much as possible for friction reduction and foreign matter removal. Therefore, the oil pressure controllability can be improved by suppressing the occurrence of oil pressure vibration.

(Processing Executed by Current Control Device)

The current control device 10 corrects the stroke-current relationship by executing processing shown in FIG. 8. The routine shown in FIG. 8 shows only a part of the processing of the microcomputer 31 and is executed at the time of ACC-ON before starting the engine or at the time of ACC-ON after stopping the engine. Hereinafter, “S” means a step.

In S1 of FIG. 8, the detection-time operation is started. In this operation, the spool 84 is axially moved from the minimum to the maximum of the stroke range while being minutely vibrated by the application of the dither amplitude. Further, in this operation, the dither amplitude is set relatively large. After S1, the processing proceeds to S2.

In S2, the oil pressure ratio is calculated and the calculated oil pressure ratio is stored as a set with the corresponding actual current. After S2, the processing proceeds to S3.

In S3, it is checked whether the spool 84 has moved to the maximum of the stroke range by the detection-time operation. If the spool 84 has moved to the maximum of the stroke range (S3: YES), the processing proceeds to S4. If the spool 84 has not moved to the maximum of the stroke range (S3: NO), the processing proceeds to S2.

In S4, the actual current of the solenoid 93 at the time when the oil pressure ratio becomes maxim is detected as the specific current. After S4, the processing proceeds to S5.

In S5, the stroke-current relationship stored in the storage unit 33 is corrected based on the specific stroke and the specific current. After S5, the processing shown in FIG. 8 and described above is finished.

(Advantage)

As described above, in the first embodiment, the current control device 10 includes the target setting unit 31, the storage unit 33, the oil pressure ratio calculation unit 37, the specific current detection unit 38 and the correction unit 39. The target setting unit 31 adds the dither amplitude to the target current so that the current of the solenoid 93 periodically changes at the dither cycle period longer than the PWM cycle period of the current control for the solenoid 93. The storage unit 33 stores the stroke-current relationship between the stroke of the spool 84 and the current of the solenoid 93. The oil pressure ratio calculation unit 37 calculates the oil pressure ratio which is the value calculated by dividing the amplitude of the output oil pressure by the average value of the output oil pressure. The specific current detection unit 38 detects the specific current based on the oil pressure ratio. The correction unit 39 corrects the stroke-current relationship based on the specific stroke and the specific current.

Thereby, the stroke of the spool 84 can be accurately determined. Therefore, the oil pressure vibration can be suppressed by changing the current control in accordance with the stroke. Therefore, the oil pressure controllability is improved.

In the first embodiment, the detection-time operation unit 36 moves the spool 84 in the axial direction while minutely vibrating the spool 84 by applying the dither amplitude at the predetermined time at which the output oil pressure is not required to be output. The specific current detection unit 38 detects, as the specific current, the current of the solenoid 93 when the oil pressure ratio becomes maximum at the time the spool 84 is moved in the axial direction by the detection-time operation unit 36. Thereby, the current when the oil pressure ratio is maximized can be easily identified.

In the first embodiment, the detection-time operation unit 36 increases the dither amplitude at the predetermined time at which the output oil pressure is not required, as compared to the normal control time at which the output oil pressure is required to be output. Thereby, the peak of the oil pressure ratio can be clarified.

In the first embodiment, the target setting unit 31 decreases the dither amplitude when the stroke of the spool 84 is at the position accompanied by the opening and closing of the input port 86 by the minute vibration at the normal control time in comparison to the case that the stroke of the spool 84 is at the position not accompanied by the opening and closing of the input port 86 by the minute vibration. As a result, the dither amplitude can be reduced at the position of the stroke range involving the opening and closing of the input port 86 to reduce the oil pressure change while increasing the amplitude of the minute vibration in the widest stroke range as much as possible for the friction reduction and the foreign matter removal.

### Second Embodiment

In a second embodiment, as in the first embodiment, the dither control that continuously causes the minute vibration among the plunger 92, the shaft 91 and the spool 84 thereby to prevent static friction from occurring among these sliding members. These sliding members slightly vibrate by applying the dither amplitude to the target current applied to the solenoid 93. When the dither amplitude is large, the amplitude of the minute vibration is also large and tends to cause separation of the plunger 92 and the shaft 91 or separation of the shaft 91 and the spool 84. If the output oil pressure is adjusted while such separation between the sliding members occurs, the change in the output oil pressure becomes large and the oil pressure controllability decreases. A current control device according to the second embodiment includes a function unit for solving such a problem and improving oil pressure controllability.

(Function Units of Current Control Device)

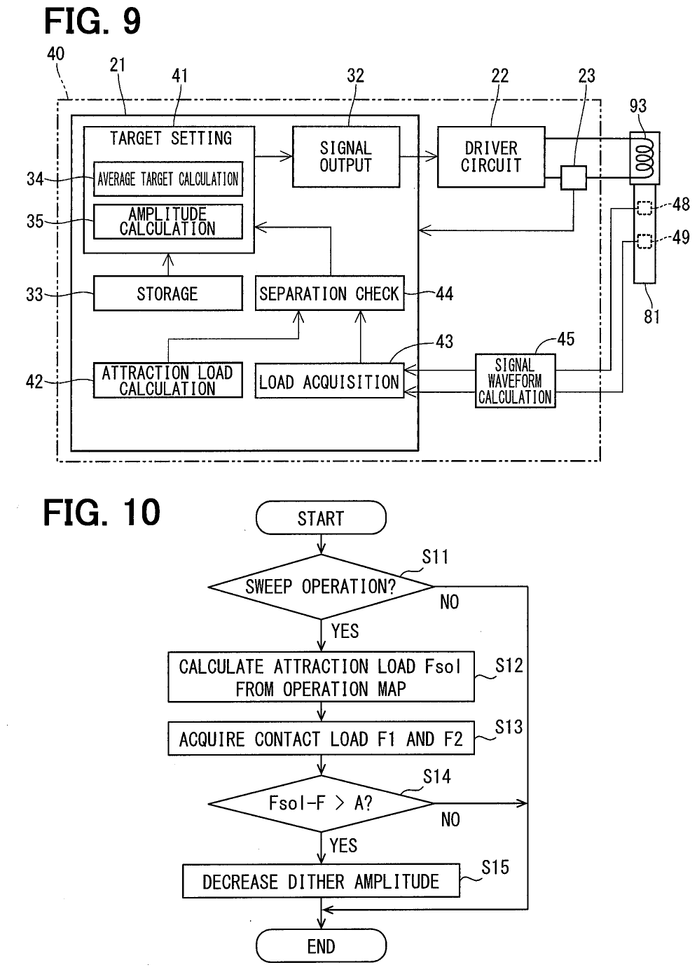

As shown in FIG. 9, a current control device 40 includes a storage unit 33 and a target setting unit 41. The target setting unit 41 adds a dither amplitude to a target current so that a current of the solenoid 93 periodically changes at a dither cycle period longer than the PWM cycle period of the current control for the solenoid 93, as in the target setting unit 31 (FIG. 3).

The current control device 40 further includes an attraction load calculation unit 42, a load acquisition unit 43 and a separation check unit 44.

The attraction load calculation unit 42 calculates an attraction load Fsol generated by energization of the solenoid 93 when the spool 84 moves in the axial direction. The attraction load Fsol is calculated based on an actual current I from a relationship between the actual current I and the attraction load Fsol stored in the storage unit 33.

The load acquisition unit 43 acquires, from a load sensor 48, a first contact load F1 acting between the plunger 92 and the shaft 91 when the spool 84 moves in the axial direction, and acquires a second contact load F2 acting between the shaft 91 and the spool 84 from a load sensor 49. The load sensor 48 is provided between the plunger 92 and the shaft 91. The load sensor 49 is provided between the shaft 91 and the spool 84.

The separation check unit 44 calculates a load difference Fsol-F between the attraction load Fsol and a contact load F. As the contact load F, the larger one of the first contact load F1 and the second contact load F2 is used. Subsequently, the separation check unit 44 checks whether the load difference “Fsol-F” is larger than a predetermined threshold value Fth. If the load difference Fsol-F is larger than a predetermined threshold value Fth, it is determined that the sliding members are not operating as instructed by the control signal and separation of any two sliding members is present. If the load difference Fsol-F is equal to or smaller than the predetermined threshold value Fth, it is determined that no separation of any sliding members is present.

The target setting unit 41 reduces the dither amplitude Ad when the separation of the two sliding members is present, as compared with the case where the separation is not present. In another embodiment, the dither cycle period may be increased instead of decreasing the dither amplitude.

Here, the load generated by the minute vibration of the dither control is added to the contact loads F1 and F2 detected by the load sensors 48 and 49. This causes deterioration in the detection accuracy of the separation of the sliding members. Therefore, the detected contact loads F1 and F2 are input to the current control device 40 after removing, by a signal waveform calculation unit 45, a frequency component of the load fluctuation caused by the minute vibration.

(Processing Executed by Current Control Device)

Next, processing performed by the current control device 40 to detect the separation of the sliding members will be described with reference to FIG. 10. The routine shown in FIG. 10 is repeatedly executed during the operation of the current control device 40.

In S11 of FIG. 10, it is checked whether a sweep operation is performed, that is, whether the spool 84 is axially moved. When the sweep operation is performed (S11: YES), the processing proceeds to S12. When the sweep operation is not performed (S11: NO), the processing of the routine of FIG. 10 is terminated.

In S12, the attraction load Fsol is calculated based on the actual current I from an operation map, that is, a relationship between the actual current I and the attraction load Fsol stored in the storage unit 33. After S12, the processing proceeds to S13.

In S13, the contact loads F1 and F2 are acquired from the load sensors 48 and 49, respectively. After S13, the processing proceeds to S14.

In S14, it is checked whether the load difference Fsol-F is larger than the predetermined threshold value Fth. If the load difference Fsol-F is larger than the predetermined threshold value Fth, it is determined that the sliding members are not operating as instructed by the control signal and the separation of any two sliding members is present. If the load difference Fsol-F is smaller than or equal to the predetermined threshold value Fth (S14: NO), it is determined that no separation of the sliding members is present, and the processing of the routine of FIG. 10 is terminated.

In S15, the dither amplitude Ad is set small. After S15, the processing of the routine of FIG. 10 is terminated.

(Advantages)

As described above, in the second embodiment, the current control device 40 includes the target setting unit 41, the attraction load calculation unit 42, the load acquisition unit 43 and the separation check unit 44. The target setting unit 41 adds the dither amplitude to the target current so that the current of the solenoid 93 periodically changes at the dither cycle period longer than the PWM cycle period of the solenoid 93. The attraction load calculation unit 42 calculates the attraction load Fsol generated by energization of the solenoid 93 when the spool 84 moves in the axial direction. The load acquisition unit 43 acquires the contact loads F1 and F2 acting between the two sliding members when the spool 84 moves in the axial direction. When the load difference between the attraction load Fsol and the contact load F is larger than the predetermined threshold value Fth, the separation check unit 44 determines that the separation of the two sliding members is present. The target setting unit 41 reduces the dither amplitude Ad when the separation of the two sliding members is present, as compared to the case where the separation is not present.

Thus, by changing the current control when the deviation between the attraction load Fsol and the contact load F is large, recovery of the followability of the sliding members to the minute vibration of the dither control can be achieved and the oil pressure vibration can be suppressed. Therefore, the oil pressure controllability is improved.

### Third Embodiment

In a third embodiment, the PWM control is used to control the current of the solenoid 93. The target current as a current commanded by a current control device to an outside has a constant frequency. Further, even when a target output oil pressure is constant, the dither control is performed to apply the minute vibration to the spool 84 in order to improve responsiveness.

In the solenoid valve 83 for oil pressure control, there is a problem that the output oil pressure largely vibrates and the oil pressure controllability decreases. In the prior art, it is proposed to detect generation of the output oil pressure vibration by a current caused by a counter-electromotive force of the solenoid 93. However, in this conventional technique, the current due to the counter-electromotive force is buried in disturbance such as current amplitude or noise due to the PWM control or dither control, and the detection accuracy is lowered. Moreover, in the detection method by filter processing, when the frequency of the target current and the frequency of the oil pressure vibration are close to each other, the oil pressure vibration cannot be detected. A current control device according to the third embodiment includes function units for solving such a problem and improving oil pressure controllability.

(Function Units of Current Control Device)

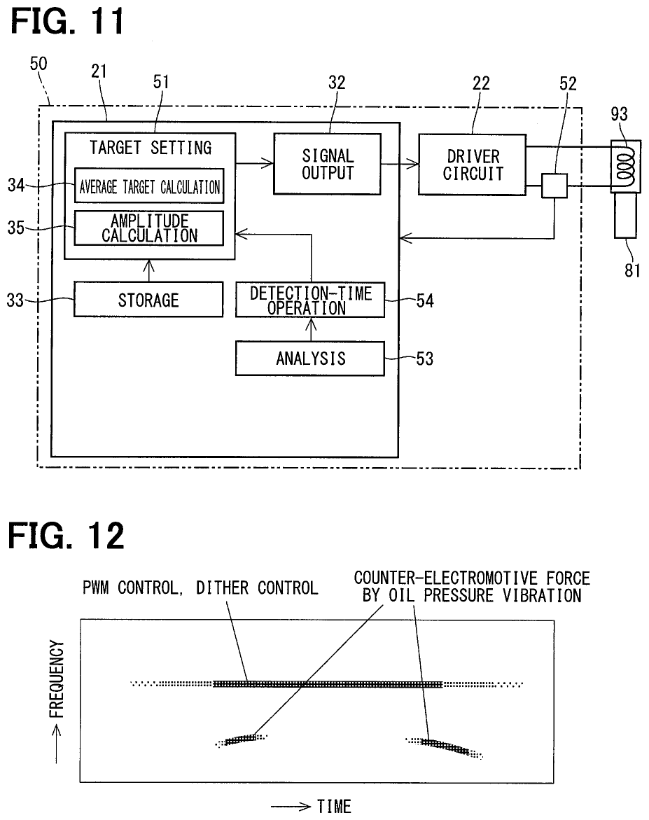

As shown in FIG. 11, a current control device 50 includes a storage unit 33 and a target setting unit 51. The target setting unit 51 adds a dither amplitude to a target current so that a current of the solenoid 93 periodically changes at the dither cycle period longer than the PWM cycle period of the solenoid 93, as in the target setting unit 31 of the first embodiment.

The current control device 50 further includes a current detection unit 52, an analysis unit 53 and an oil vibration check unit 54.

The current detection unit 52 detects a value related to the oil pressure change when a spool 84 moves in the axial direction. The value related to the oil pressure change is variable with the oil pressure change, and is a value that changes at the same time as the output oil pressure changes, and is the actual current of the solenoid 93 in the third embodiment. The current detection unit 52 may be the same as the current detection unit 23 of the first embodiment.

The analysis unit 53 performs time frequency analysis of the actual current as a value related to the oil pressure change, and extracts a specific frequency component that changes with time. When the actual current is subjected to the time frequency analysis, it can be separated into a constant frequency component and a specific frequency component changing with time as shown in FIG. 12. The constant frequency component is a frequency of the PWM control and the dither control, and is a known frequency determined by the current control device 50. On the other hand, the specific frequency component that changes with time is not the target current, but the frequency of the current due to the counter-electromotive force caused by the oil pressure vibration. The frequency of the specific frequency component increases as the target current increases and the output oil pressure increases. Conversely, the frequency of the specific frequency component decreases as the target current decreases and the output hydraulic pressure decreases.

As shown in FIG. 13, the relationship between the target current (effective value) and the frequency of the specific frequency component is in a proportional relationship. Using this relationship, an oil pressure vibration check unit 54 shown in FIG. 11 determines that hydraulic pressure vibration is present when there is the proportional relationship between the target current and the frequency of the specific frequency component.

When it is determined that the oil vibration is present, the target setting unit 51 changes the current control, such as inverting a phase of the dither control or increasing the dither frequency by 4/3, for example, thereby to suppress the oil pressure vibration.

(Processing Executed by Current Control Device)

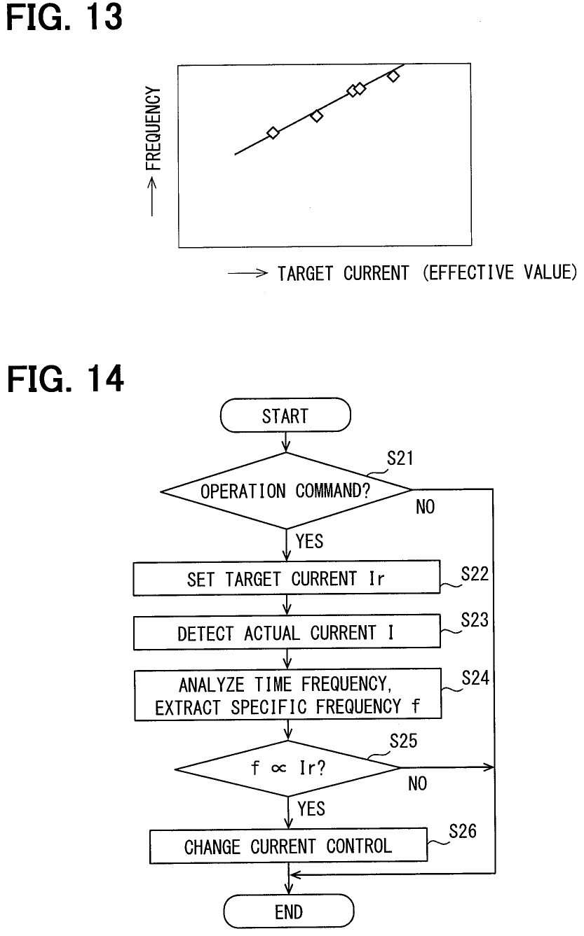

Next, processing that the current control device 50 executes to suppress the oil pressure vibration will be described with reference to FIG. 14. The routine shown in FIG. 14 is repeatedly performed during the operation of the current control device 50.

In S21 of FIG. 14, it is checked whether there is an instruction to a sweep operation, that is, whether there is an instruction to move the spool 84 in the axial direction. When the sweep instruction is issued (S21: YES), the processing proceeds to S22. When the sweep instruction is not issued (S21: NO), the processing of the routine of FIG. 14 is terminated.

In S22, a target current Ir is set. After S22, the processing proceeds to S23.

In S23, an actual current is detected as a value related to the oil pressure change. After S23, the processing proceeds to S24.

In S24, the time frequency analysis of the actual current is performed, and the frequency f of the specific frequency component that changes with time is extracted. After S24, the processing proceeds to S25.

In S25, it is checked whether there is a proportional relationship between the target current Ir and the frequency f of the specific frequency component. If there is the proportional relationship between the target current Ir and the frequency f (S25: YES), it is determined that oil pressure vibration is present, and the processing proceeds to S26. If there is no proportional relationship between the target current Ir and the frequency f (S25: NO), it is determined that no oil pressure vibration is present, and the processing terminates the routine of FIG. 14.

In S26, a current control change that reverses the phase of the dither control is made. After S15, the processing of the routine of FIG. 10 is terminated.

(Advantages)

As described above, in the third embodiment, the current control device 50 includes the current detection unit 52, the analysis unit 53, and the oil pressure vibration check unit 54. The current detection unit 52 detects the actual current as the hydraulic pressure change related value when the spool 84 moves in the axial direction. The analysis unit 53 performs the time frequency analysis of the actual current and extracts the specific frequency component that changes with time. When there is the proportional relationship between the target current and the frequency of the specific frequency component, the hydraulic pressure vibration check unit 54 determines that the oil pressure vibration is present.

As described above, the occurrence of the oil pressure vibration can be detected based on the presence or absence of the proportional relationship between the target current Ir and the frequency f of the specific frequency component. Because of the check operation based on the presence or absence of the proportionality relation, it is possible to separate accurately the constant frequency component, which is included in the target current of the PWM control and the dither control, and the frequency component of the current, which is generated by the counter-electromotive force caused by the oil pressure vibration, even if the constant frequency component and the frequency component caused by the oil pressure vibration are close to each other. Fort this reason, the oil pressure vibration can be suppressed by changing the current control when the oil pressure vibration occurs. Therefore, the oil pressure controllability is improved.

### OTHER EMBODIMENTS

In the third embodiment, the value related to the oil pressure change is the actual current. In another embodiment, the value related to the oil pressure change may be the output oil pressure or the stroke of the spool. In particular, when the value related to the oil pressure change is the output oil pressure, the frequency of the oil pressure vibration can be detected with high sensitivity. In addition, since the oil pressure vibration also includes secondary and tertiary frequency components, the accuracy can be further enhanced by including these frequencies.

In the embodiments described above, the functions of the electronic control unit is exemplified as being executed by software by the microcomputer 10, 40, 50. However, the processing of the electronic control unit, that is, the functions shown in the block form, may alternatively be executed by a hardware circuit.

The present disclosure is not limited to the embodiments described above, and various modifications are possible within the scope of the present disclosure without departing from the spirit of the invention.

What is claimed is:

1. A current control device for controlling a current of a solenoid of a solenoid valve, in which a spool is moved in an axial direction inside a sleeve in accordance with a current supplied to the solenoid to regulate an output oil pressure, one of an input port and an output port of the sleeve which is opened and closed by the spool is defined to be a specific port, a stroke of the spool at which the spool momentarily closes the specific port is defined to be a specific stroke, and the current of the solenoid corresponding to the specific stroke is defined to be a specific current, the current control device comprising an electronic control unit configured to execute processing of:
adding a dither amplitude to a target current to change the current of the solenoid periodically at a dither cycle period longer than an energization cycle period of the solenoid;
storing a stroke-current relationship between the stroke of the spool and the current of the solenoid;
calculating an oil pressure ratio which is calculated by dividing an amplitude of the output oil pressure by an average value of the output oil pressure;
detecting the specific current based on the oil pressure ratio; and
correcting the stroke-current relationship based on the specific stroke and the specific current.

2. The current control device according to claim 1, wherein the electronic control unit is further configured to execute processing of:
moving the spool in the axial direction at a predetermined time at which the output oil pressure is not required to be output, while minutely vibrating the spool with an application of the dither amplitude,
wherein the processing of detecting the specific current detects, as the specific current, the current of the solenoid when the oil pressure ratio is maximum during movement of the spool in the axial direction caused by the processing of moving the spool.

3. The current control device according to claim 2, wherein:
the processing of moving the spool increases the dither amplitude or decrease the dither cycle period at the predetermined time at which the output oil pressure is not required to be output, in comparison to a normal control time at which the output oil pressure is required to be output.

4. The current control device according to claim 3, wherein:
the processing of setting the target decreases the dither amplitude in the normal control time when the stroke of the spool is at a position of opening and closing the specific port by a minute vibration of the stroke of the spool in comparison to a case when the stroke of the spool is at a position of no opening nor closing of the specific port by the minute vibration.

5. A current control device for controlling a current of a solenoid of a solenoid valve, in which a plurality of sliding members are moved in an axial direction in accordance with a current supplied to the solenoid to regulate an output oil pressure, the current control device comprises an electronic control unit configured to execute processing of:
adding a dither amplitude to a target current to change the current of the solenoid periodically at a dither cycle period longer than an energization cycle period of the solenoid;
calculating an attraction load generated by energization of the solenoid when the spool is moved in the axial direction;
acquiring a contact load acting between two sliding members of the plurality of sliding members when the spool is moved in the axial direction;
determining a presence of separation of the two sliding members when a load difference between the attraction load and the contact load is larger than a predetermined value,
wherein the processing of adding the dither amplitude reduces the dither amplitude or increases the dither cycle period when the separation of the two sliding members is present in comparison to a case when no separation is present.

6. A current control device for controlling a current of a solenoid of a solenoid valve, in which a spool is moved in an axial direction in accordance with a current supplied to the solenoid to regulate an output oil pressure, the current control device comprising an electronic control unit configured to execute processing of:
setting a target current of the solenoid;
detecting a value related to an oil pressure change when the spool is moved in the axial direction;
extracting a specific frequency component which changes with time by performing a time frequency analysis of the value related to the oil pressure change; and
determining a presence of an oil pressure vibration when there is a proportional relationship between the target current and a frequency of the specific frequency component.

7. The current control device according to claim 6, wherein:
the value related to the oil pressure change is an actual current of the solenoid.

8. The current control device according to claim 6, wherein:
the value related to the oil pressure change is the output oil pressure.

9. The current control device according to claim 6, wherein:
the value related to the oil pressure change is the stroke of the spool.
